(19) United States
(12) Patent Application Publication
(10) Pub. No.: US 2026/0343110 A1
(43) Pub. Date: Oct. 29, 2026

(54) ELECTRONIC DEVICE AND CONTROL DEVICE OF ELECTRONIC DEVICE

(71) Applicant: SAMSUNG ELECTRONICS CO., LTD., Suwon-si (KR)

(72) Inventors: Heungsuk KANG, Suwon-si (KR); Cheulhee HAHM, Suwon-si (KR); Gimun EOM, Suwon-si (KR)

(73) Assignee: SAMSUNG ELECTRONICS CO., LTD., Suwon-si (KR)

(21) Appl. No.: 19/712,973

(22) Filed: Jun. 18, 2026

Related U.S. Application Data
(63) Continuation of application No. PCT/KR2024/016801, filed on Oct. 30, 2024.

(30) Foreign Application Priority Data
Dec. 28, 2023 (KR) 10-2023-0195408

(51) Int. Cl. H04N 25/131; G06F 3/042; G06T 7/13; G06T 7/70; G06V 10/143; H04N 23/72; H04N 23/73; H04N 23/74; H04N 23/75; H04N 23/76; H04N 25/13; H04N 9/31; H04R 3/00

(52) U.S. Cl. CPC H04N 25/131; G06F 3/0425; G06T 7/13; G06T 7/70; G06V 10/143; H04N 23/72; H04N 23/73; H04N 23/74; H04N 23/75; H04N 23/76; H04N 25/134; G06T 2207/10024; G06T 2207/10048; G06T 2207/30196; H04N 9/31; H04R 3/00

(57) ABSTRACT

An electronic device and a control method of the electronic device are provided. The electronic device projects an optical image to a projection area, outputs infrared light to the projection area, acquires an image of the projection area by using an image sensor provided with a dual band pass filter, acquires a visible light image and an infrared image on the basis of the image of the projection area, recognizes position information of a touch point by a subject in the projection area on the basis of the acquired visible light image and infrared image, and controls the operation of a projection part on the basis of the recognized position information of the touch point.

### CROSS-REFERENCE TO RELATED APPLICATIONS

[1] This application is a bypass continuation application of International Application No. PCT/KR2024/016801, filed on Oct. 30, 2024, which claims priority to Korean Patent Application No. 10-2023-0195408, filed on Dec. 28, 2023, in the Korean Ministry of Intellectual Property, the disclosures of which are incorporated by reference herein in their entireties.

### BACKGROUND

### FIELD

The present disclosure relates to an electronic device and a control method thereof for obtaining an image and recognizing a subject in the obtained image.

### DESCRIPTION OF RELATED ART

As imaging technology continues to advance, various electronic devices provided with image sensors have been developed. For example, the electronic devices may include display devices, vision systems, user authentication devices, mobile devices, and projectors.

Among these devices, a projector enlarges and projects image light emitted from a light source onto a wall or screen through a projection lens.

Recently, the use of portable projectors has been increasing, and the projectors are evolving from one-way projectors that simply project images (e.g., photos, movies, etc.) to interactive projectors that allow users to manipulate displayed images by applying a touch input to the display surface where the projected images (e.g., UI images) are displayed.

A key aspect of such interactive projectors is the technology that recognizes the position of a touch point input by a user.

Currently, the technology for recognizing the position of a touch point in the interactive projector is based on infrared (IR) recognition technology.

More specifically, the interactive projector recognizes an image projected by the projector by using a first image sensor capable of recognizing visible light of the three primary colors (RGB), recognizes a subject in the projection area by using a second image sensor capable of recognizing infrared ray (IR), and recognizes the position of a touch point input by a user based on the recognized image and the recognized subject.

### SUMMARY

Provided are an electronic device and a control method thereof for obtaining a visible light image and an infrared image using an image sensor provided with a dual band pass filter and recognizing a subject based on the obtained visible light image and infrared image.

Further, provided are an electronic device and a control method thereof for obtaining a visible light image and an infrared image by adjusting at least one of an exposure value or a gain value of an image sensor provided with a dual band pass filter.

Additional aspects will be set forth in part in the description which follows and, in part, will be apparent from the description, or may be learned by practice of the presented embodiments.

According to an aspect of the disclosure, an electronic device includes a projection portion comprising at least one lens and configured to project an optical image onto a projection area; a light emitter configured to emit infrared light; an image sensor comprising a dual band pass filter, the image sensor being configured to obtain an image of the projection area; memory storing instructions; and at least one processor operatively connected to the memory. The instructions, when executed by the at least one processor individually or collectively, cause the electronic device to: obtain a visible light image and an infrared image based on the image of the projection area received from the image sensor, and recognize position information of a touch point input by a subject within the projection area based on the visible light image and the infrared image.

The dual band pass filter may be configured to block light in a wavelength band corresponding to red visible light, pass light in wavelength bands corresponding to blue and green visible light, and pass light in a wavelength band corresponding to infrared light. The instructions, when executed by the at least one processor individually or collectively, may cause the electronic device to: recognize a border of the projection area based on the visible light image, recognize infrared coordinates and the touch point based on the infrared image, and recognize the position information of the touch point based on the recognized border of the projection area, the recognized infrared coordinates, and the recognized touch point.

The dual band pass filter may be configured to block light in a wavelength band corresponding to red visible light, pass light in wavelength bands corresponding to blue and green visible light, and pass light in a wavelength band corresponding to infrared light. The instructions, when executed by the at least one processor individually or collectively, cause the electronic device to obtain the infrared image by removing blue and green colors from the image of the projection area received from the image sensor.

The instructions, when executed by the at least one processor individually or collectively, may cause the electronic device to: obtain the visible light image based on the image of the projection area obtained by the image sensor during execution of a first sensing mode, and obtain the infrared image based on the image of the projection area obtained by the image sensor during execution of a second sensing mode.

The instructions, when executed by the at least one processor individually or collectively, may cause the electronic device to: adjust an exposure value of the image sensor to a first exposure value during the execution of the first sensing mode, and adjust the exposure value of the image sensor to a second exposure value during the execution of the second sensing mode. The first exposure value is greater than the second exposure value.

The instructions, when executed by the at least one processor individually or collectively, may cause the electronic device to: adjust a gain value of the image sensor to a first gain value during the execution of the first sensing mode, and adjust the gain value of the image sensor to a second gain value during the execution of the second sensing mode. The first gain value is greater than the second gain value.

The instructions, when executed by the at least one processor individually or collectively, may cause the electronic device to adjust at least one of an exposure value or a gain value of the image sensor based on the image of the projection area obtained by the image sensor.

The instructions, when executed by the at least one processor individually or collectively, may cause the electronic device to: recognize a user input based on the recognized position information of the touch point, and control an operation of the projection portion based on the recognized user input.

The electronic device may further includes a speaker configured to output audio content. The instructions, when executed by the at least one processor individually or collectively, may cause the electronic device to: recognize a user input based on the recognized position information of the touch point, and control an operation of the speaker based on the recognized user input.

According to an aspect of the disclosure, an electronic device includes a light emitter configured to emit infrared light; an image sensor comprising a dual band pass filter, the image sensor being configured to obtain an image of a projection area; memory storing instructions; and at least one processor operatively connected to the memory. The instructions, when executed by the at least one processor individually or collectively, cause the electronic device to: obtain a visible light image and an infrared image based on the image of the projection area received from the image sensor, and recognize a subject based on the visible light image and the infrared image. The electronic device further includes a display configured to display information corresponding to the recognized subject.

The dual band pass filter may be configured to block light in a wavelength band corresponding to red visible light, pass light in wavelength bands corresponding to blue and green visible light, and pass light in a wavelength band corresponding to infrared light. The instructions, when executed by the at least one processor individually or collectively, may cause the electronic device to: obtain the infrared image by removing blue and green colors from the image of the projection area received from the image sensor, and recognize a shape of the subject based on the infrared image.

The instructions, when executed by the at least one processor individually or collectively, may cause the electronic device to: obtain the visible light image based on the image of the projection area obtained from the image sensor during execution of a first sensing mode, and obtain the infrared image based on the image of the projection area obtained from the image sensor during execution of a second sensing mode.

The instructions, when executed by the at least one processor individually or collectively, may cause the electronic device to: adjust an exposure value of the image sensor to a first exposure value and a gain value of the image sensor to a first gain value during the execution of the first sensing mode, and adjust the exposure value of the image sensor to a second exposure value and the gain value of the image sensor to a second gain value during the execution of the second sensing mode, wherein the first exposure value is greater than the second exposure value, and wherein the first gain value is greater than the second gain value.

The instructions, when executed by the at least one processor individually or collectively, may cause the electronic device to: adjust the exposure value of the image sensor by controlling a shutter speed of the image sensor or an aperture opening degree of the image sensor.

The aperture opening degree during execution of the first sensing mode may be greater than the aperture opening degree during execution of the second sensing mode.

The shutter speed during execution of the first sensing mode may be faster than the shutter speed during execution of the second sensing mode.

According to an aspect of the disclosure, a method of controlling an electronic device includes projecting, by a projection portion of the electronic device comprising at least one lens, an optical image onto a projection area; emitting infrared light onto the projection area; obtaining, by an image sensor of the electronic device, an image of the projection area, wherein the image sensor comprises a dual band pass filter, and the dual band pass filter is configured to block light in a wavelength band corresponding to red visible light, pass light in wavelength bands corresponding to blue and green visible light, and pass light in a wavelength band corresponding to infrared light; obtaining a visible light image and an infrared image based on the image of the projection area; recognizing position information of a touch point input by a subject within the projection area based on the visible light image and the infrared image; and controlling an operation of the projection portion based on the recognized position information of the touch point.

The recognizing the position information of the touch point may include: obtaining the infrared image by removing blue and green colors from the image of the projection area, recognizing a border of the projection area based on the visible light image, recognizing infrared coordinates and the touch point based on the infrared image, and recognizing the position information of the touch point based on the recognized border of the projection area, the recognized infrared coordinates, and the recognized touch point.

The obtaining of the visible light image and the infrared image based on the image of the projection area may include: during execution of a first sensing mode, adjusting an exposure value of the image sensor to a first exposure value and adjusting a gain value of the image sensor to a first gain value, during execution of a second sensing mode, adjusting the exposure value of the image sensor to a second exposure value and adjusting the gain value of the image sensor to a second gain value, the first exposure value being greater than the second exposure value, and the first gain value being greater than the second gain value, obtaining the visible light image based on the image of the projection area obtained by the image sensor during the execution of the first sensing mode, and obtaining the infrared image based on the image of the projection area obtained by the image sensor during the execution of the second sensing mode.

The method may further include recognizing a user input based on the recognized position information of the touch point, and controlling the operation of the projection portion based on the recognized user input.

According to one or more embodiments of the present disclosure, by obtaining a visible light image and an infrared image by using an image sensor provided with a dual band pass filter, recognition accuracy of the visible light image and infrared image may be improved.

According to one or more embodiments of the present disclosure, by recognizing a visible light image and an infrared image obtained by a single image sensor, the number of the image sensor provided in an electronic device may be reduced and therefore manufacturing cost may be reduced.

According to one or more embodiments of the present disclosure, because a view field of an infrared image and a view field of a visible light image are the same when a position of a touch point is recognized, accuracy of recognizing the position of the touch point may be improved.

According to one or more embodiments of the present disclosure, because an image is projected by using a laser light source, a bright and clear image may be projected both in the daytime and at night, thereby improving a user’s image recognition rate.

Embodiments of the present disclosure may improve marketability of an electronic device, further increase user satisfaction, improve user reliability, and secure product competitiveness.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 shows an example of an electronic device according to an embodiment;

FIG. 2 shows an example of a projection portion provided in an electronic device according to an embodiment;

FIG. 3 shows an example of an image sensor provided in a projector according to an embodiment;

FIG. 4 is a graph showing quantum efficiencies for wavelength bands of light received by an image sensor provided in a projector according to an embodiment;

FIG. 5 is a graph showing transmittances for wavelength bands of light transmitted through a dual band pass filter and a first color filter provided in an image sensor of a projector according to an embodiment;

FIG. 6 is a control configuration diagram of an electronic device according to an embodiment;

FIGS. 7, 8, and 9 show an example of obtaining an image in a projector according to an embodiment;

FIG. 10 shows an example of recognizing a position of a touch point in a projector according to an embodiment;

FIG. 11 is a control flowchart of an electronic device according to an embodiment; and

FIG. 12 is a control configuration diagram of an electronic device according to another embodiment.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

Terms such as “1^{st}”, “2^{nd}”, or “first” or “second” may be used simply to distinguish a component from other components, without limiting the component in other aspects (e.g., importance or order).

A certain (e.g., a first) component is referred to as “coupled” or “connected” with or without the terms “functionally” or “communicatively” to another (e.g., second) component. When mentioned, it means that any of the above components can be connected to the other components directly (e.g., by wire), wirelessly, or via a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a certain component is referred to as being “on” or “over” another component, it can be directly on the other component or intervening components may also be present.

As used herein, the term “and/or” includes any and all combinations of one or more of associated listed items.

It is to be understood that each embodiment described herein may apply to one or more other embodiments.

Hereinafter, an operation principle and embodiments of the disclosure will be described with reference to the accompanying drawings.

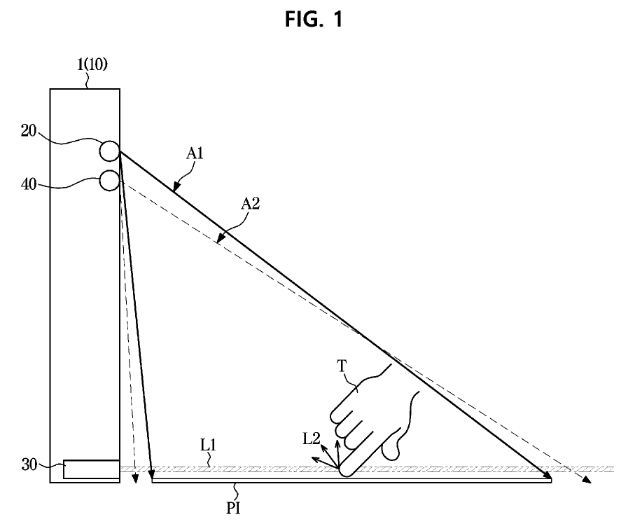

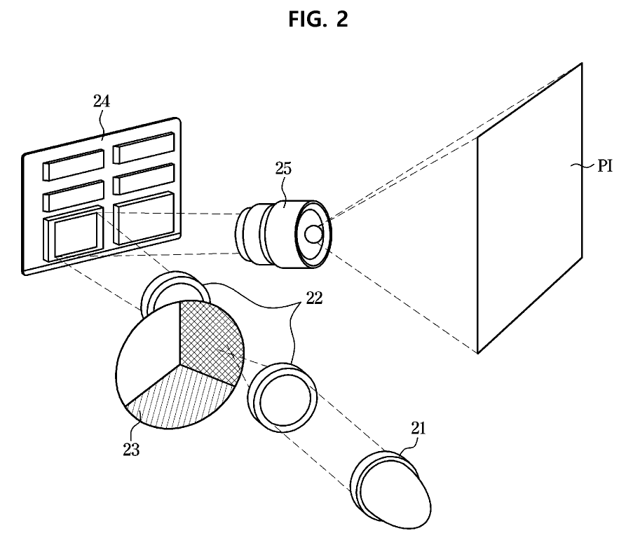

FIG. 1 shows an example of an electronic device according to an embodiment, and will be described with reference to FIGS. 2 to 5. In the present embodiment, a projector among electronic devices will be described.

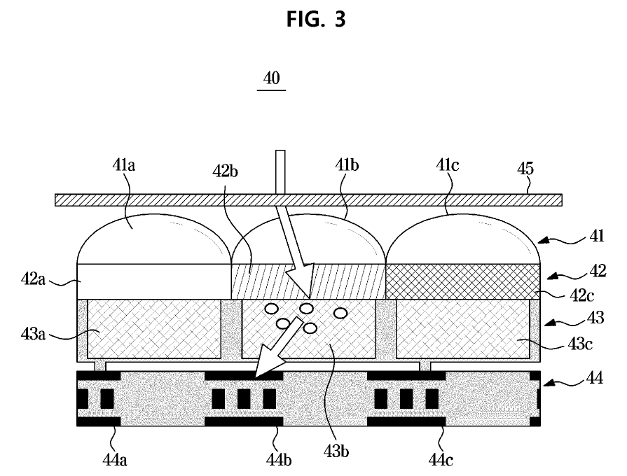

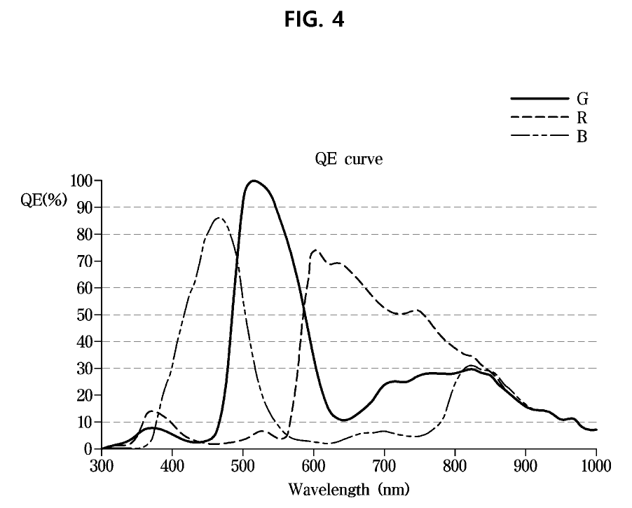

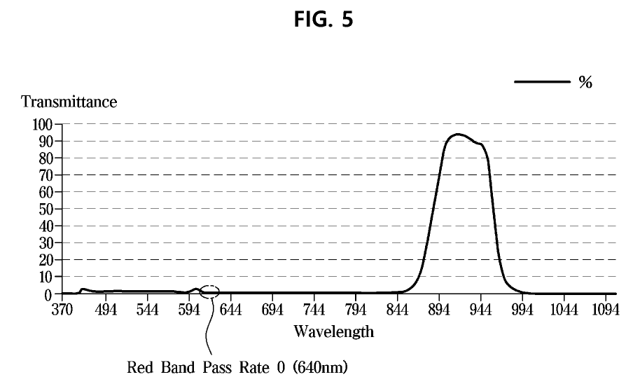

FIG. 2 shows an example of a projection portion provided in a projector according to an embodiment, FIG. 3 shows an example of an image sensor provided in a projector according to an embodiment, FIG. 4 is a graph showing quantum efficiencies for wavelength bands of light received by an image sensor provided in a projector according to an embodiment, and FIG. 5 is a graph showing transmittances for wavelength bands of light transmitted through a dual band pass filter and a first color filter provided in an image sensor of a projector according to an embodiment.

A projector 1 may be an optical device that projects content, such as photos, videos, documents, etc., onto a screen, wall, or floor.

The projector 1 may project images at home, parks, campsites, or beaches, without spatial restrictions. In other words, the projector 1 may be a portable and movable device.

The projector 1 may recognize a touch input by a user and change an image of content based on the recognized touch input.

The projector 1 may include a main body 10 forming an appearance.

The main body 10 may be provided with a projection portion 20, a light emitter 30, and an image sensor 40, and exposed to outside.

The projection portion 20 may be provided at an upper end of the main body 10.

The projection portion 20 may receive content from an external device, enlarge an image of the received content, and output the enlarged image of the content as light.

The projection portion 20 may have a first view field A1 and output an image corresponding to the first view field A.

An image PI of content output from the projection portion 20 may be an optical image by laser light and projected onto a screen, wall or floor.

The external device may include, but is not limited to, a personal computer, a laptop, a tablet PC, a terminal, a portable telephone, a smart phone, a handheld device, a wearable device, and a set-top box.

The external device may further include a portable storage device, such as Universal Serial Bus (USB) memory and a hard disk, and may further include a server.

The external device may store content and transmit the stored content to the projector 1. The content may include at least one of image information or sound information.

The projection portion 20 may be categorized into Cathode-Ray Tube (CRT), Digital Light Processing (DLP), Liquid Crystal Display (LCD), and Liquid Crystal on Silicon (LCoS) types depending on projection methods for projecting images.

The CRT type may be a method of amplifying an image of content received from an external device through a cathode ray tube and projecting the amplified image onto a screen through a lens.

The LCD type may be a method of transmitting light emitted from a light source through an LCD panel to obtain an image and projecting the obtained image through a lens.

The LCoS type may be a combination of the LCD and DLP types and may be a method of generating an image using an LCD panel and DLP chip and projecting the generated image through a lens.

The DLP type may be a method of processing light emitted from a light source in a Digital Micromirror Device (DMD) chip to generate an image and projecting the generated image through a lens.

In a case where the projection portion 20 is the DLP type, as shown in FIG. 2, the projection portion 20 may include a light source 21, a lens 22, a color wheel 23, a DMD chip 24, and a projection lens 25.

The light source 21 may include a laser light source. The light source 21 may output light with preset reference brightness or higher. Here, the preset reference brightness may be about 500 lux.

The lens 22 may include, but is not limited to, a condensing lens that concentrates light emitted from the light source 21 and a shaping lens that transmits light passed through the color wheel 23 to the DMD chip 24.

The color wheel 23 may transmit light of three primary colors (RGB) among light emitted from the light source 21. The light of three primary colors transmitted through the color wheel 23 may pass through the shaping lens and then be incident onto the DMD chip 24.

The DMD chip 24 may include a plurality of mirrors and mix the light of three primary colors by turning the plurality of mirrors on and off at high speed to generate an image of content.

The projection lens 25 may enlarge the image of the content generated in the DMD chip 24 and output the image of the content. An image PI of content output through the projection lens 25 may be projected onto a screen, wall, or floor.

The image PI of the content generated in the DMD chip 24 may be an optical image formed by laser light.

FIG. 2 is an example for describing a basic operation of the projection portion 20 based on the DLP type, and a structure of the projection portion 20 based on the DLP type is not limited thereto.

A projection method of the projector according to embodiments of the present disclosure is not limited to the CRT, DLP, LCD, and LCoS types.

The light emitter 30 may be provided at a lower end of the main body 10.

The light emitter 30 may emit infrared light L1 to generate infrared coordinates on a screen, wall, or floor.

The screen, wall, or floor may be a projection area on which an image output from the projection portion 20 is projected. That is, the infrared coordinates may be formed on the projection area on which an image output from the projection portion 20 is projected.

Hereinafter, the screen, wall, or floor is collectively referred to as a projection area.

The infrared coordinates may be coordinates for recognizing a touch point by a user’s touch input.

The light emitter 30 may include a plurality of IR emitters arranged at regular intervals.

The image sensor 40 may be provided at the upper end of the main body 10.

The image sensor 40 may be adjacent to the projection portion 20.

The image sensor 40 may have a second view field A2 and obtain an image corresponding to the second view field A2. The second view field A2 may be larger than the first view field A1 of the projection portion 20. That is, the image sensor 40 may obtain an image having a larger area than the projection area on which an image of content is projected.

The image sensor 40 may obtain an image of content and an image of a subject within the second view field A2. Here, the subject may include a user’s hand, a user’s foot, a pen, a pointer, etc., which make a touch input.

The image obtained by the image sensor 40 may include a visible light image.

The image obtained by the image sensor 40 may include an infrared image.

More specifically, when a subject T exists on the image PI of the projection area, infrared light emitted from the light emitter 30 may be scattered or diffused at the subject T. In this case, the image sensor 40 may obtain an image of infrared light L2 scattered by the subject T and a coordinate image formed by the infrared light emitted from the light emitter 30.

The image sensor 40 may include, but is not limited to, a Complementary Metal Oxide Semiconductor (CMOS).

As shown in FIG. 3, the image sensor 40 may include a micro lens portion 41, a color filter portion 42, a photodiode portion 43, a circuit board 44, and a dual band pass filter 45. A CMOS will be described as an example of the image sensor.

The micro lens portion 41 may concentrate incident light. The incident light may be light received from the projection area, and include visible light corresponding to an image of content, natural light, and infrared light emitted from the light emitter 30.

The micro lens portion 41 may include a plurality of micro lenses.

The number of the micro lenses may vary depending on an application and needs. Also, the plurality of micro lenses may be arranged in various configurations on the same plane. For example, the plurality of micro lenses may be aligned in a horizontal or vertical direction, or in a matrix form in horizontal and vertical directions.

In the current embodiment, three micro lenses will be described. That is, the micro lens portion 41 may include a first micro lens 41a, a second micro lens 41b, and a third micro lens 41c.

The color filter portion 42 may filter the light concentrated by the micro lens portion 41.

The color filter portion 42 may pass light in a preset wavelength band among the light concentrated by the micro lens portion 41.

The preset wavelength band may include a first wavelength band, a second wavelength band, and a third wavelength band. The first, second, and third wavelength bands may be different wavelength bands.

The first wavelength band may include a wavelength band corresponding to infrared light, the second wavelength band may include a wavelength band corresponding to green light, and the third wavelength band may include a wavelength band corresponding to blue light.

For example, the first wavelength band may include a wavelength band from 850 nm to 950 nm. The second wavelength band may include a wavelength band from 500 nm to 565 nm. The third wavelength band may include a wavelength band from 400 nm to 485 nm.

The color filter portion 42 may include a first color filter 42a, a second color filter 42b, and a third color filter 42c.

The first color filter 42a may be provided at a position corresponding to the first micro lens 41a.

The first color filter 42a may pass light in the first wavelength band among light transmitted through the dual band pass filter 45.

More specifically, because light in a wavelength band of red visible light is blocked by the dual band pass filter 45 and not incident, the first color filter 42a may pass light in the first wavelength band corresponding to infrared light.

The wavelength band of red visible light may include a wavelength band of 625 nm to 750 nm.

The second color filter 42b may be provided at a location corresponding to the second micro lens 41b.

The second color filter 42b may pass light in the second wavelength band among light transmitted through the dual band pass filter 45.

The third color filter 42c may be provided at a location corresponding to the third micro lens 41c.

The third color filter 42c may pass light in the third wavelength band among light transmitted through the dual band pass filter 45.

The photodiode portion 43 may be adjacent to the color filter portion 42.

The photodiode portion 43 may convert received light into electrons.

The photodiode portion 43 may include a first photodiode 43a that is adjacent to the first color filter 42a and converts light in the first wavelength band passed through the first color filter 42a into electrons, a second photodiode 43b that is adjacent to the second color filter 42b and converts light in the second wavelength band passed through the second color filter 42b into electrons, and a third photodiode 43c that is adjacent to the third color filter 42c and converts light in the third wavelength band passed through the third color filter 42c into electrons.

The circuit board 44 may include a plurality of analog/digital circuits 44a, 44b, and 44c that convert electrons into digital signals, and may include an image signal processor that performs image signal processing based on digital signals converted by the plurality of analog/digital circuits.

More specifically, a first analog-digital circuit 44a may be adjacent to the first photodiode 43a and convert electrons converted by the first photodiode 43a into a digital signal.

A second analog-digital circuit 44b may be adjacent to the second photodiode 43b and convert electrons converted by the second photodiode 43b into a digital signal.

A third analog-digital circuit 44c may be adjacent to the third photodiode 43c and convert electrons converted by the third photodiode 43c into a digital signal.

The image signal processor may obtain an image by performing image processing based on the digital signals converted by the first, second, and third analog-digital circuits 44a, 44b, and 44c.

The dual band pass filter 45 may be adjacent to the micro lens portion 41.

The dual band pass filter 45 may block light in a reference wavelength band among light being incident onto the dual band pass filter 45 and pass light in a remaining wavelength band.

The reference wavelength band may include a wavelength band of 625 nm to 750 nm. For example, the reference wavelength band may include a wavelength band of about 640 nm.

The remaining wavelength band may include the first, second, and third wavelength bands. For example, the remaining wavelength band may include a wavelength band of 400 nm to 565 nm and a wavelength band of 850 nm to 950 nm.

The dual band pass filter 45 may block red visible light and pass green and blue visible light. The dual band pass filter 45 may pass light of infrared light (IR).

This will be described with reference to FIGS. 4 to 5.

FIG. 4 is a graph showing Quantum Efficiencies (QE) for wavelength bands of light received by the image sensor 40, and FIG. 5 is a graph showing transmittances for wavelength bands of light transmitted through the dual band pass filter 45 and the first color filter 42a.

As shown in FIG. 4, a wavelength band (that is, the reference wavelength band) corresponding to red visible light received by a general image sensor is 625 nm to 750 nm.

Based on this, the present embodiment may prevent red visible light from being incident onto the image sensor 40 by blocking light in the reference wavelength band by using the dual band pass filter 45.

As shown in FIG. 4, even in the second and third wavelength bands, visible light is received by the image sensor 40. That is, visible light in the second and third wavelength bands is received by the first color filter 42a.

Based on this, the image sensor according to the present embodiment has reduced transmittances of the dual band pass filter with respect to the second and third wavelength bands. That is, transmittances of light in the second and third wavelength bands of the dural band pass filter 45 according to the present disclosure may be lower than or equal to a first transmittance.

A transmittance of light in the first wavelength band of the dural band pass filter 45 may be higher than or equal to a second transmittance.

A transmittance of red visible light of the dual band pass filter 45 may be about 0 %.

Here, the second transmittance may be higher than the first transmittance.

For example, the first transmittance for light in the second and third wavelength bands may be about 5 %, and the second transmittance for the first wavelength band may be about 95 %.

The dual band pass filter 45 may pass light in the second and third wavelength bands with the first transmittance, pass light in the first wavelength band with the second transmittance, and pass red visible light with a transmittance of about 0%. That is, the dual band pass filter 45 may block red visible light from passing through.

As shown in FIG. 5, the image sensor 40 may pass light in the wavelength band corresponding to infrared light through the dual band pass filter 35 and the first color filter 42a.

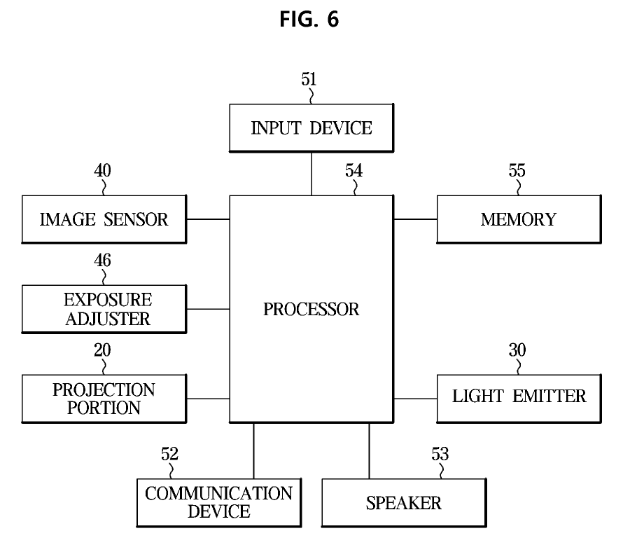

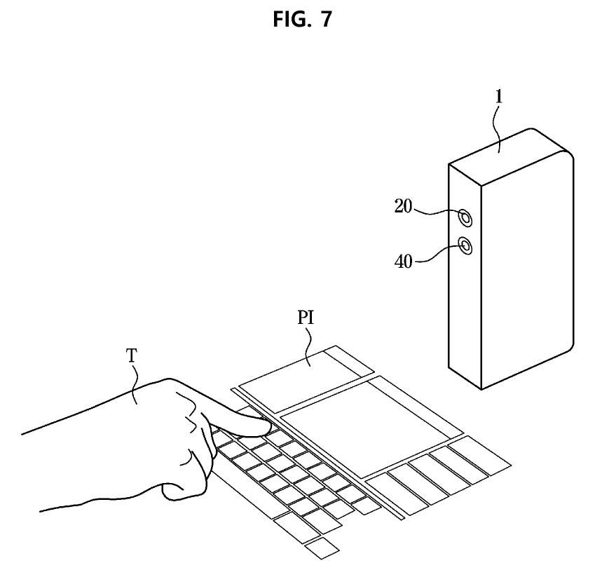

FIG. 6 is a control configuration diagram of an electronic device according to an embodiment, and will be described with reference to FIGS. 7 to 10. A control configuration of a projector among electronic devices will be described.

FIGS. 7, 8, and 9 show an example of obtaining an image and recognizing a position of a touch point in a projector according to an embodiment.

The projector 1 may include the projection portion 20, the light emitter 30, the image sensor 40, an input device 51, a communication device 52, a speaker 53, at least one processor 54, and memory 55.

The projection portion 20 may adjust brightness of an image, a size of the image, and a projection direction of the image based on a control command from the processor 54.

The projection portion 20 may output an image of content based on a control command from the processor 54, and change an image of content to be output based on a control command from the processor 54.

Here, the content may include content selected by a user.

The projection portion 20 may also output a preset basic image based on reception of a power-on command for the projector.

The projection portion 20 may output an image of content by using a light source that emits light with preset reference brightness or higher. Here, the preset reference brightness may be about 500 lux.

The light source provided in the projection portion 20 may include a laser light source.

The light emitter 30 may emit infrared light L1 onto a projection area based on a control command from the processor 54.

The image sensor 40 may obtain an image of the projection area and transmit the obtained image to the processor 54.

As shown in FIG. 7, in a case where a user’s hand exists at a point within an image PI of content projected on a floor, the image sensor 40 may obtain the image PI of the content displayed on a projection area and an image of a subject T. Here, the subject T may include a user’s hand or foot that makes a touch input, and may include an indicator, such as a pen and a pointer.

The image sensor 40 may include the dual band pass filter 45 that blocks light in a reference wavelength band. Light in a remaining wavelength band may be incident onto the image sensor 40. The image sensor 40 may obtain first and second images by using the light in the remaining wavelength band.

The reference wavelength band may include a wavelength band corresponding to red visible light.

The remaining wavelength band may include a wavelength band corresponding to green visible light, a wavelength band corresponding to blue visible light, and a wavelength band corresponding to infrared light.

The dual band pass filter 45 may pass light in the wavelength band of green visible light and light in the wavelength band of blue visible light. The dual band pass filter may be a dual band color pass filter.

The image sensor 40 may obtain an image during execution of a first sensing mode and may obtain an image during execution of a second sensing mode, based on a control command from the processor 54.

The projector 1 may further include an exposure adjuster 46 for adjusting an exposure value.

The exposure adjuster 46 may further include at least one of a shutter or an aperture that is adjacent to the image sensor 40.

The shutter may pass light for a preset time period to adjust an amount of light that is incident onto the image sensor.

The aperture may adjust an opening degree to adjust an amount of light that is incident onto the image sensor 40.

The input device 51 may receive a user input.

The user input may include a power-on command and a power-off command.

The user input may include setting information for a resolution, a focal point, contrast, brightness, sharpness, a screen size (i.e., an image size), etc.

The user input may include information for selecting content.

The input device 51 may receive an on command for a touch function and an off command for the touch function.

The input device 51 may include a hardware device, such as various buttons, a switch, a keyboard, a mouse, a track-ball, various levers, a handle, or a stick.

Also, the input device 51 may include a Graphical User Interface (GUI) such as a touch pad, that is, a software device.

The communication device 52 may communicate with a remote controller and an external device. The communication device 52 may receive content from the external device.

The communication device 52 may receive a user input from the remote controller and transmit the received user input to the processor.

The communication device 52 may communicate with a home appliance at home and may also communicate with a server.

The communication device 52 may receive operation information of the home appliance at home or transmit a control command to the home appliance at home. The communication device 52 may receive content from the server.

The communication device 52 may include at least one of a short-range communication module or a long-distance communication module.

The communication device 52 may transmit data to the external device or receive data from the external device. For example, the communication device 52 may establish communication with the external device and transmit/receive various data.

To this end, the communication device 52 may establish a direct (e.g., wired) communication channel or a wireless communication channel with the external device and support communication through the established communication channel.

According to an embodiment, the communication device 52 may include a wireless communication module (e.g., a cellular communication module, a short-range communication module, or a global navigation satellite system (GNSS) communication module) or a wired communication module (e.g., a local area network (LAN) communication module or a power line communication module).

The communication device 52 may communicate with the external device through a first network (e.g., a short-range communication network, such as Bluetooth, WiFi Direct, or Infrared data association (IrDA)) or a second network (e.g., a long-range communication network, such as a legacy cellular network, a 5G network, a next-generation communication network, the Internet, or a computer network (e.g., a LAN or a wide area network (WAN)). The various kinds of communication modules may be integrated into a single component (e.g., a single chip) or implemented with a plurality of separate components (e.g., a plurality of chips).

The short-range wireless communication module may include, but is not limited thereto, a Bluetooth communication module, a Bluetooth Low Energy (BLE) communication module, a Near Field Communication (NFC) communication module, a Wireless Local Area Network (WLAN; WiFi) communication module, a Zigbee communication module, an IrDA communication module, a Wi-Fi Direct (WFD) communication module, a Ultrawideband (UWB) communication module, an Ant+ communication module, a microwave (uWave) communication module, etc.

The speaker 53 may output audio information of content.

The speaker 53 may turn audio on or off or adjust a volume of audio based on a control command from the processor 54.

The processor 54 may control overall operations of the projector 1.

The processor 54 may control activation of various components provided in the projector 1 based on a power-on command received through the input device 51, and control deactivation of various components provided in the projector 1 based on a power-off command received through the input device 51.

The processor 54 may control operations of the projection portion 20, the light emitter 30, the image sensor 40, the communication device 52, and the speaker 53 based on a user input received through the input device 51.

The processor 54 may control communication with the external device based on a user input received through the input device 51.

The processor 54 may receive content from the external device based on a user input received through the input device 51 and control an output of the received content.

The content received from the external device may include content selected by the user.

The processor 54 may control deactivation of the light emitter 30 and the image sensor 40 based on reception of the off command for the touch function, and control activation of the light emitter 30 and the image sensor 40 based on reception of the on command for the touch function.

The processor 54 may control at least one of the projection portion 20 or the speaker 53 based on reception of an output command of content.

Based on image information being included in the content, the processor 54 may control an operation of the projection portion 20, based on audio information being included in the content, the processor 54 may control an operation of the speaker 53, and based on image information and audio information being included in the content, the processor 54 may control operations of the projection portion 20 and the speaker 53.

An operation of the processor after a touch-on command is received will be described.

The processor 54 may control the projection portion 20 to project an image of content.

While the image of the content is projected, the processor 54 may control the image sensor 40, and based on images received from the image sensor 40, the processor 54 may obtain first and second images and recognize position information of a touch point based on the obtained first and second images.

An image of a projection area may include an image of content.

The image of the projection area may include an image of content and an image of a subject that makes a touch input.

While an image of content is projected, the processor 54 may control the light emitter 30 to output infrared light. Therefore, infrared coordinates may be formed on the projection area.

While the image of the content is projected, the processor 54 may control execution of a first sensing mode and a second sensing mode.

The processor 54 may execute the first sensing mode and then control execution of the second sensing mode.

To minimize visible light in the second and third wavelength bands from being incident onto the image sensor, the processor 54 may adjust an amount of light that is incident onto the image sensor 40, based on control of execution of the first and second sensing modes.

The processor 54 may adjust an amount of light that is incident onto the image sensor 40 differently while executing the first and second sensing modes.

The first sensing mode may be a mode for obtaining a visible light image and the second sensing mode may be a mode for obtaining an infrared image.

Based on this, the processor 54 may control an amount of light that is incident onto the image sensor 40 such that an amount of light incident onto the image sensor 40 during execution of the first sensing mode is more than an amount of light incident onto the image sensor 40 during execution of the second sensing mode.

To adjust an amount of light that is incident onto the image sensor 40, the processor 54 may adjust at least one of an exposure value or a gain value of the image sensor 40.

That is, based on control of execution of the first sensing mode, the processor 54 may adjust at least one of an exposure value or a gain value of the image sensor, and based on control of execution of the second sensing mode, the processor 54 may adjust at least one of an exposure value or a gain value of the image sensor.

While the processor 54 executes the first sensing mode, the processor 54 may adjust an exposure value of the image sensor 40 to a first exposure value and a gain value of the image sensor to a first gain value.

While the processor 54 executes the second sensing mode, the processor 54 may adjust an exposure value of the image sensor 40 to a second exposure value and a gain value of the image sensor to a second gain value.

The first exposure value may be greater than the second exposure value. For example, the first exposure value may be about 62.5 msec and the second exposure value may be about 7.8 msec.

The first gain value may be greater than the second gain value. For example, the first gain value may be about four times greater than the second gain value.

Adjusting a gain value may include adjusting an intensity of an electrical signal of an image of the image sensor 40.

The processor 54 may also control sensitivity (ISO: International Standard Organization) to adjust an exposure value of the image sensor 40.

That is, the processor 54 may adjust at least one of an exposure value or a gain value of the image sensor 40 such that an amount of light incident through the image sensor 40 during execution of the first sensing mode is more than an amount of light incident through the image sensor 40 during execution of the second sensing mode.

The projector 1 may further include the exposure adjuster 46 that adjusts an exposure value of the image sensor 40 based on a control command from the processor 54.

The exposure adjuster 46 may include at least one of a shutter or an aperture.

That is, the processor 54 may control at least one of a shutter speed or an aperture opening degree to adjust an exposure value of the image sensor.

The processor 54 may control a shutter speed during execution of the first sensing mode to be faster than a shutter speed during execution of the second sensing mode.

The processor 54 may control an opening degree of the aperture during execution of the first sensing mode to be greater than an opening degree of the aperture during execution of the second sensing mode.

The processor 54 may adjust an exposure value of the image sensor 40 to the first exposure value and adjust a gain value to the first gain value such that an amount of light received through the image sensor 40 is more than an amount of light received through the image sensor during execution of the second sensing mode.

The processor 54 may adjust an exposure value of the image sensor 40 to the first exposure value and adjust a gain value to the first gain value to allow light in the first, second, and third wavelength bands to be incident through the dual band pass filter 45 and the color filter portion 42 of the image sensor in such a way that the incident light in the second and third wavelength bands is more than that during execution of the second sensing mode.

As a result, during execution of the first sensing mode, the processor 54 may increase an amount of blue visible light and an amount of green visible light passing through the dual band pass filter 45 and the color filter portion 42 of the image sensor 40.

During execution of the first sensing mode, the processor 54 may receive an image from the image sensor 40 and obtain a first image based on the received image.

The first image may be an image of blue and green visible light. In a case where red visible light is not 100% blocked by the dual band pass filter and the color filter portion, the first image may be an image of red, blue and green visible light.

The processor 54 may recognize a border of the projection area based on the obtained first image.

The processor 54 may adjust an exposure value of the image sensor 40 to the second exposure value and adjust a gain value to the second gain value such that an amount of light received through the image sensor 40 is less than an amount of light received through the image sensor 40 during execution of the first sensing mode.

As a result, during execution of the second sensing mode, the processor 54 may decrease an amount of blue visible light and an amount of green visible light passing through the dual band pass filter 45 and the color filter portion 42 of the image sensor 40, and increase an amount of infrared light.

The processor 54 may adjust the exposure value of the image sensor 40 to the second exposure value and adjust the gain value to the second gain value to allow light in the first, second, and third wavelength bands to be incident through the dual band pass filter 45 and the color filter portion 42 of the image sensor 40 in such a way that an amount of the incident light in the second and third wavelength bands is less than that in the first sensing mode.

During execution of the second sensing mode, the processor 54 may receive an image from the image sensor 40 and obtain a second image based on the received image.

During execution of the second sensing mode, the processor 54 may remove green and blue colors from the image received from the image sensor 40 and remain a red color. The processor 54 may obtain the second image by using the red color remaining in the received image and recognize infrared coordinates and a touch point based on the obtained second image.

Light passed through the dual band pass filter 45 and the color filter portion 42 of the image sensor 40 may be infrared light, and when green and blue colors are removed from an image received from the image sensor 40 during execution of the second sensing mode, the infrared light passed through the first color filter may remain.

The second image may be an image obtained by the infrared light and include infrared coordinates and an image of the infrared light scattered by a subject.

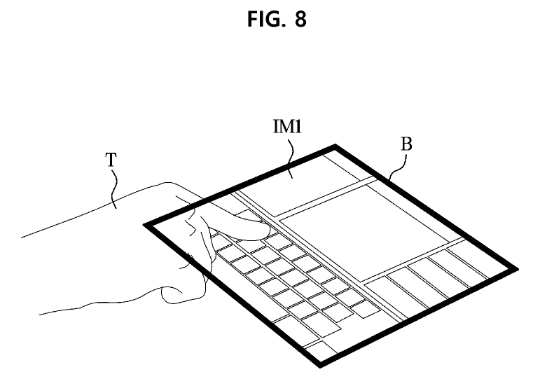

As shown in FIG. 8, the processor 54 may recognize a border B of a projection area based on a first image IM1.

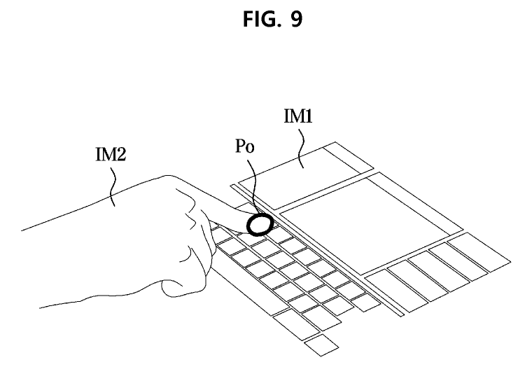

As shown in FIG. 9, the processor 54 may recognize a subject contacting the projection area based on a second image IM2 and recognize a touch point Po by the subject. The processor 54 may recognize coordinates in the projection area based on the second image IM2, which is not shown.

The processor 54 may recognize a point at which infrared light is scattered based on the second image IM2 and recognize the recognized, scattered point as a touch point.

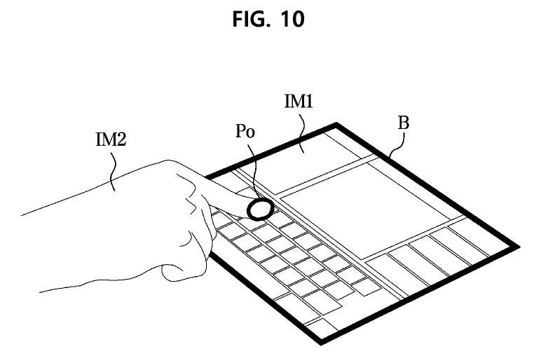

As shown in FIG. 10, the processor 54 may obtain position information of the touch point based on the recognized border B, the recognized touch point Po, and the coordinates.

The processor 54 may recognize a user input based on the position information of the touch point, and control operations of the projection portion 20 and the speaker 53 or an operation of the communication device 52 based on the recognized user input.

The processor 54 may recognize the user input based on the position information of the touch point and change an image of content to be projected based on the recognized user input.

The processor 54 may recognize whether the user input is a tap, double tap, press, flick, swipe, drag, pinch, or rotate, based on the position information of the touch point.

The processor 54 may adjust an exposure value of the image sensor 40 to the first exposure value and a gain value to the first gain value and then control the image sensor 40 to obtain an image of the projection area.

The processor 54 may obtain a first image based on an image received from the image sensor 40, remove green and blue colors and remain a red color from the received image, obtain a second image by using the remaining red color, recognize a border of a projection area based on the obtained first image, recognize infrared coordinates and a touch point based on the obtained second image, and recognize position information of the touch point based on the recognized border, infrared coordinates, and touch point.

The border of the projection area may be a border of the image of the content projected on a screen, floor, or wall.

The processor 54 may include hardware, such as a central processing unit (CPU) and memory, and software such as a control program. For example, the processor 54 may include at least one memory that stores data in the form of an algorithm or program for controlling operations of components in the projector 1, and one, two, or more processing chips or one, two, or more processing cores that perform the above-described operations by using the data stored in the at least one memory.

The processor 54 may include a separate Neural Processing Unit (NPU) that performs operations of an artificial intelligence model and may include a Graphics Processing Unit (GPU).

The memory 55 may store coordinate information by infrared light emitted from the light emitter.

The memory 55 may store the first exposure value and the first gain value corresponding to the first sensing mode, and the second exposure value and the second gain value corresponding to the second sensing mode.

The memory 55 may store data on an algorithm for controlling operations of components within the projector 1 or a program that reproduces the algorithm.

The memory 55 and processor 54 may be implemented as separate chips. Alternatively, the memory 55 and processor 54 may be implemented as a single chip.

The memory 55 may be implemented as at least one of a non-volatile memory device, such as a cache, Read Only Memory (ROM), Programmable ROM (PROM), Erasable Programmable ROM (EPROM), Electrically Erasable Programmable ROM (EEPROM), and flash memory, a volatile memory device such as Random Access Memory (RAM), or a storage medium, such as Hard Disk Drive (HDD) and Compact Disc Read Only Memory (CD-ROM), although not limited thereto.

At least one component may be added or omitted to correspond to performance of components of the projector shown in FIG. 6. Also, it will be easily understood by one of ordinary skill in the art that mutual positions of the components may change to correspond to the performance and structure of a system.

Meanwhile, the components shown in FIG. 6 may be software components and/or hardware components, such as a Field Programmable Gate Array (FPGA) and an Application Specific Integrated Circuit (ASIC).

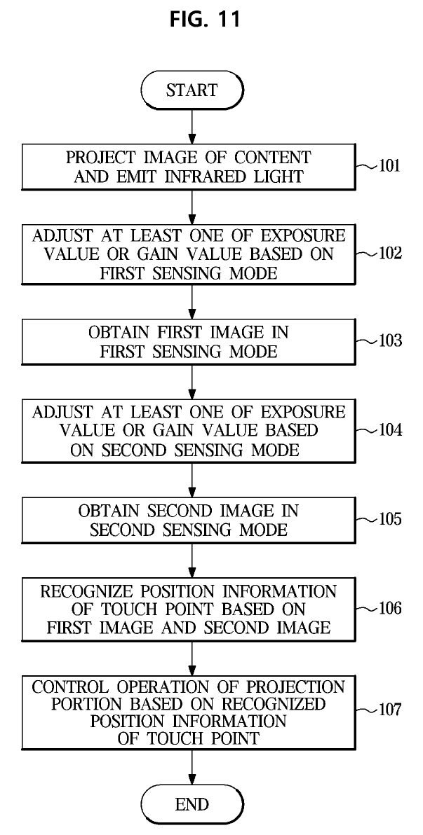

FIG. 11 is a control flowchart of an electronic device according to an embodiment.

A projector will be described as an example of the electronic device.

Based on reception of an output command of content, the projector may control the projection portion to project an image of the content onto a projection area and control the light emitter to emit infrared light to form infrared coordinates on the projection area (101).

The projector may execute the first sensing mode, and based on the execution of the first sensing mode, the projector may adjust an amount of light that is incident onto the image sensor 40.

Adjusting the amount of light that is incident onto the image sensor 40 may be to minimize red visible light from being incident onto the image sensor.

Adjusting the amount of light that is incident onto the image sensor 40 may include adjusting at least one of an exposure value or a gain value.

During the execution of the first sensing mode, the projector may adjust an exposure value of the image sensor 40 to the first exposure value and a gain value of the image sensor to the first gain value (102).

During the execution of the first sensing mode, the projector may obtain an image of the projection area by using the image sensor 40 and obtain a first image based on the obtained image (103).

By adjusting the exposure value of the image sensor 40 to the first exposure value and the gain value to the first gain value during the execution of the first sensing mode, the projector may allow light in the first, second, and third wavelength bands to be incident through the dual band pass filter 45 and the color filter portion 42 of the image sensor in such a way as to allow green visible light and blue visible light to be incident and allow infrared light to be incident. That is, the projector may minimize red visible light from being incident by adjusting an amount of light that is incident onto the image sensor.

The first image may be an image of blue and green visible light.

In a case where red visible light is not 100% blocked by the dual band pass filter and the color filter portion, the first image may be an image of red, blue and green visible light.

The projector may recognize a border of the projection area based on the obtained first image.

According to execution completion of the first sensing mode, the projector may execute the second sensing mode.

The projector may adjust at least one of an exposure value or a gain value of the image sensor such that an amount of light incident onto the image sensor during the execution of the second sensing mode is less than an amount of light incident onto the image sensor during execution of the first sensing mode.

That is, during the execution of the second sensing mode, the projector may adjust an exposure value of the image sensor 40 to the second exposure value and a gain value of the image sensor to the second gain value (104).

During the execution of the second sensing mode, the projector may obtain an image of the projection area by using the image sensor 40 and obtain a second image based on the obtained image (105).

Infrared light passed through the dual band pass filter 45 and the first color filter may be recognized as a red color because the infrared light has passed through the first color filter.

Based on this, during the execution of the second sensing mode, the projector may remove green and blue colors from an image received from the image sensor 40 to remain a red color, obtain the second image by using the remaining red color, and recognize infrared coordinates and a touch point based on the obtained second image.

The remaining red color may have been recognized by infrared light.

That is, light passed through the dual band pass filter 45 and the color filter portion 42 of the image sensor 40 may be infrared light, and by removing green and blue colors from an image received from the image sensor 40 during execution of the second sensing mode, the infrared light passed through the first color filter may remain.

The projector may obtain the second image based on the remaining infrared light.

The second image may be an infrared image and include infrared coordinates and an image of the infrared light scattered by a subject.

The projector may recognize position information of the touch point based on the recognized board, touch point, and infrared coordinates (106).

The projector may recognize a user input based on the position information of the touch point and control an operation of the projection portion 20 based on the recognized user input (107).

The projector may recognize the user input based on the position information of the touch point, and control an operation of the speaker 53 or an operation of the communication device 52 based on the recognized user input.

According to the present embodiment, because the first image and the second image are obtained by using a single image sensor, a view field of the image sensor for obtaining the first image may be the same as a view field of the image sensor for obtaining the second image. This means that a position where the border of the projection area is obtained is the same as a position where the infrared coordinates are obtained. According to the present embodiment, because there is no difference between the position where the border of the projection area is obtained and the position where the infrared coordinates are obtained, recognition accuracy of a touch position may increase.

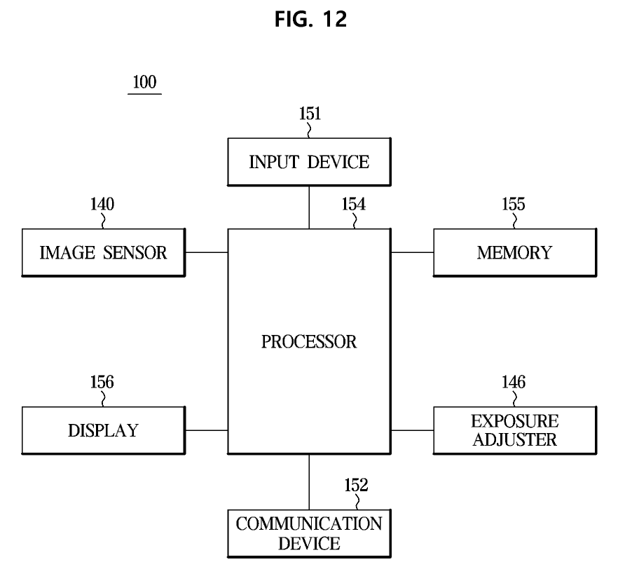

FIG. 12 is a control flowchart of an electronic device according to another embodiment.

A vision system will be described as an example of the electronic device.

A vision system 100 may include a light emitter 130, an image sensor 140, an exposure adjuster 146, an input device 151, a communication device 152, a processor 154, memory 155, and a display 156.

The light emitter 130 may emit infrared light. A direction in which infrared light is emitted may be the same as a direction in which an image is obtained through the image sensor 140.

The image sensor 140 may obtain an image and transmit the obtained image to the processor 154.

The image sensor 140 may include a micro lens portion, a color filter portion, a photodiode portion, a circuit board, and a dual band pass filter (see FIG. 3). The image sensor 140 according to another embodiment may be the same as the image sensor 40 according to an embodiment, and therefore, descriptions thereof will be omitted.

The vision system 100 may further include an exposure adjuster 146 for adjusting an exposure value of the image sensor 140.

The exposure adjuster 146 may further include at least one of a shutter or an aperture that is adjacent to the image sensor 140.

The shutter may pass light for a preset time period to adjust an amount of light that is incident onto the image sensor.

The aperture may adjust an opening degree to adjust an amount of light that is incident onto the image sensor 140.

The input device 151 may receive a user input.

The user input may include a power-on command and a power-off command.

The user input may include a shooting command for performing a vision function.

The input device 151 may include a hardware device, such as various buttons, a switch, a keyboard, a mouse, a track-ball, various levers, a handle, and a stick.

Also, the input device 151 may include a GUI such as a touch pad, that is, a software device.

The communication device 152 may perform communication between components in the vision system and communication with an external device. The communication device 152 may be the same as the communication device 52 according to an embodiment, and therefore, descriptions thereof will be omitted.

The display 156 may display an image based on a control command from the processor 154.

The display 156 may display an image obtained by the image sensor 140 and display information on a subject in the image obtained by the image sensor 140.

In the case of a vision system for object recognition, the display 156 may display information on a recognized object.

In the case of a vision system for user authentication, the display 156 may display authentication result information corresponding to user authentication success or user authentication failure.

The display156 may be provided as a CRT, a DLP panel, a plasma display panel, an LCD panel, an electroluminescence (EL) panel, an electrophoretic display (EPD) panel, an electrochromic display (ECD) panel, a light emitting diode (LED) panel, or an organic light emitting diode (OLED) panel, but is not limited thereto.

The processor 154 may control overall operations of the vision system 100.

The processor 154 may control activation of various components provided in the vision system 100 based on a power-on command received through the input device 151, and control deactivation of various components provided in the vision system 100 based on a power-off command received through the input device 151.

The processor 154 may control operations of the light emitter 130, the image sensor 140, and the exposure adjuster 146 based on a user input received through the input device 151.

While the processor 154 performs the vision function, the processor 154 may control the image sensor 140, obtain first and second images based on images received from the image sensor 140, recognize a subject based on the obtained first and second images, and control the display 156 to display information on the recognized subject.

While the processor 154 performs the vision function, the processor 154 may control the light emitter 130 to output infrared light. Therefore, the infrared light may be scattered by the subject.

While the processor 154 performs the vision function, the processor 154 may control execution of the first sensing mode and the second sensing mode.

The processor 154 may execute the first sensing mode and then control execution of the second sensing mode.

To minimize red visible light from being incident onto the image sensor 140, the processor 154 may adjust an amount of light that is incident onto the image sensor 140 based on control of execution of the first and second sensing modes.

The processor 154 may adjust an amount of light that is incident onto the image sensor 40 differently while executing the first and second sensing modes.

The first sensing mode may be a mode for obtaining a visible light image and the second sensing mode may be a mode for obtaining an infrared image.

Based on this, the processor 154 may control an amount of light that is incident onto the image sensor 40 such that an amount of light incident onto the image sensor 40 during execution of the first sensing mode is more than an amount of light incident onto the image sensor 40 during execution of the second sensing mode.

To adjust an amount of light that is incident onto the image sensor 140, the processor 154 may adjust at least one of an exposure value or a gain value of the image sensor 140.

During execution of the first sensing mode, the processor 154 may adjust an exposure value of the image sensor 140 to the first exposure value and a gain value of the image sensor to the first gain value.

During execution of the second sensing mode, the processor 154 may adjust an exposure value of the image sensor 140 to the second exposure value and a gain value of the image sensor 140 to the second gain value.

The first exposure value may be greater than the second exposure value. The first gain value may be greater than the second gain value.

Adjusting the gain value may include adjusting an intensity of an electrical signal of an image of the image sensor 140.

The processor 154 may control the exposure adjuster 146 that adjusts an exposure value of the image sensor 140. That is, the processor 154 may control at least one of a shutter speed or an aperture opening degree to adjust an exposure value of the image sensor 140.

The processor 154 may control a shutter speed during execution of the first sensing mode to be faster than a shutter speed during execution of the second sensing mode.

The processor 154 may control an opening degree of the aperture during execution of the first sensing mode to be greater than an opening degree of the aperture during execution of the second sensing mode.

During execution of the first sensing mode, the processor 154 may receive an image from the image sensor 140 and obtain a first image based on the received image.

The first image may be an image of blue and green visible light. In a case where red visible light is not 100% blocked by the dual band pass filter and color filter portion, the first image may be an image of red, blue and green visible light.

The processor 154 may recognize a subject based on the obtained first image.

The processor 154 may adjust an exposure value of the image sensor 140 to the second exposure value and a gain value to the second gain value such that an amount of light received through the image sensor 140 is less than an amount of light received through the image sensor 140 during execution of the first sensing mode.

During the execution of the second sensing mode, the processor 154 may receive an image from the image sensor 140 and obtain a second image based on the received image.

During the execution of the second sensing mode, the processor 154 may remove green and blue colors from the image received from the image sensor 140 and remain a red color. The processor 154 may obtain the second image by using the red color remaining in the received image and recognize a shape of the subject based on the obtained second image.

Light passed through the dual band pass filter and the color filter portion of the image sensor 140 may be infrared light, and when green and blue colors are removed from an image received from the image sensor 140 during the execution of the second sensing mode, the infrared light passed through the first color filter may remain.

The second image may be an image obtained by the infrared light and include an image of the infrared light scattered by the subject.

The processor 154 may recognize the subject based on the first image and the second image.

In a case where the vision function is a function for user authentication, the processor 154 may recognize whether the user is a pre-registered user based on information on the recognized subject and information on a subject stored in the memory 155.

That is, according to similarity between information on a recognized subject and information on a subject stored in the memory 155 being higher than or equal to reference similarity, the processor 154 may recognize that a user corresponding to the subject is a pre-registered user and determine user authentication success, and according to the similarity between the information on the recognized subject and the information on the subject stored in the memory 155 being lower than the reference similarity, the processor 154 may recognize that the user corresponding to the subject is not a pre-registered user and determine user authentication failure.

In a case where the vision function is a function for object recognition, the processor 154 may, based on the information on the recognized subject and the information on the subject stored in the memory 155, recognize an object corresponding to the subject, and control the display 156 to display information corresponding to the recognized object.

The processor 154 may include hardware, such as a CPU and memory, and software such as a control program. For example, the processor 154 may include at least one memory that stores data in the form of an algorithm or program for controlling operations of components in the vision system 100, and one, two, or more processor chips or one, two, or more processing cores that perform the above-described operations by using the data stored in the at least one memory.

The processor 154 may include a separate NPU for performing operations of an artificial intelligence model and may include a GPU, etc.

The memory 155 may store shape information for each subject.

The memory 155 may store the first exposure value and the first gain value corresponding to the first sensing mode, and store the second exposure value and the second gain value corresponding to the second sensing mode.

The memory 155 may store data on an algorithm for controlling operations of components within the vision system 100 or a program that reproduces the algorithm.

The memory 155 and processor 154 may be implemented as separate chips. Alternatively, the memory 155 and processor 154 may be implemented as a single chip.

The memory 155 may be implemented as at least one of a non-volatile memory device, such as a cache, ROM, PROM, EPROM, EEPROM, and flash memory, a volatile memory device, such as RAM, or a storage medium, such as HDD and CD-ROM, although not limited thereto.

At least one component may be added or omitted to correspond to performance of components in the vision system shown in FIG. 12. Also, it will be easily understood by one of ordinary skill in the art that mutual positions of the components may change to correspond to the performance and structure of a system.

Meanwhile, the components shown in FIG. 12 may be software components and/or hardware components, such as a FPGA and an ASIC.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be ROM, RAM, a magnetic tape, a magnetic disc, flash memory, an optical data storage device, etc.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the present disclosure. Thus, it should be understood that the disclosed embodiments are merely for illustrative purposes and not for limitation purposes.

What is claimed is:

1. An electronic device comprising:
a projection portion comprising at least one lens and configured to project an optical image onto a projection area;
a light emitter configured to emit infrared light;
an image sensor comprising a dual band pass filter, the image sensor being configured to obtain an image of the projection area;
memory storing instructions; and
at least one processor operatively connected to the memory,
wherein the instructions, when executed by the at least one processor individually or collectively, cause the electronic device to:
obtain a visible light image and an infrared image based on the image of the projection area received from the image sensor, and
recognize position information of a touch point input by a subject within the projection area based on the visible light image and the infrared image.

2. The electronic device of claim 1, wherein the dual band pass filter is configured to block light in a wavelength band corresponding to red visible light, pass light in wavelength bands corresponding to blue and green visible light, and pass light in a wavelength band corresponding to infrared light, and
wherein the instructions, when executed by the at least one processor individually or collectively, cause the electronic device to:
recognize a border of the projection area based on the visible light image,
recognize infrared coordinates and the touch point based on the infrared image, and
recognize the position information of the touch point based on the recognized border of the projection area, the recognized infrared coordinates, and the recognized touch point.

3. The electronic device of claim 1, wherein the dual band pass filter is configured to block light in a wavelength band corresponding to red visible light, pass through light in wavelength bands corresponding to blue and green visible light, and pass through light in a wavelength band corresponding to infrared light, and
wherein the instructions, when executed by the at least one processor individually or collectively, cause the electronic device to obtain the infrared image by removing blue and green colors from the image of the projection area received from the image sensor.

4. The electronic device of claim 1, wherein the instructions, when executed by the at least one processor individually or collectively, cause the electronic device to:
obtain the visible light image based on the image of the projection area obtained by the image sensor during execution of a first sensing mode, and
obtain the infrared image based on the image of the projection area obtained by the image sensor during execution of a second sensing mode.

5. The electronic device of claim 4, wherein the instructions, when executed by the at least one processor individually or collectively, cause the electronic device to:
adjust an exposure value of the image sensor to a first exposure value during the execution of the first sensing mode, and
adjust the exposure value of the image sensor to a second exposure value during the execution of the second sensing mode, and
wherein the first exposure value is greater than the second exposure value.

6. The electronic device of claim 4, wherein the instructions, when executed by the at least one processor individually or collectively, cause the electronic device to:
adjust a gain value of the image sensor to a first gain value during the execution of the first sensing mode, and
adjust the gain value of the image sensor to a second gain value during the execution of the second sensing mode, and
wherein the first gain value is greater than the second gain value.

7. The electronic device of claim 1, wherein the instructions, when executed by the at least one processor individually or collectively, cause the electronic device to adjust at least one of an exposure value or a gain value of the image sensor based on the image of the projection area obtained by the image sensor.

8. The electronic device of claim 1, wherein the instructions, when executed by the at least one processor individually or collectively, cause the electronic device to:
recognize a user input based on the recognized position information of the touch point, and
control an operation of the projection portion based on the recognized user input.

9. An electronic device comprising:
a light emitter configured to emit infrared light;
an image sensor comprising a dual band pass filter, the image sensor being configured to obtain an image of a projection area;
memory storing instructions;
at least one processor operatively connected to the memory,
wherein the instructions, when executed by the at least one processor individually or collectively, cause the electronic device to:
obtain a visible light image and an infrared image based on the image of the projection area received from the image sensor, and
recognize a subject based on the visible light image and the infrared image; and
a display configured to display information corresponding to the recognized subject.

10. The electronic device of claim 9, wherein the dual band pass filter is configured to block light in a wavelength band corresponding to red visible light, pass through light in wavelength bands corresponding to blue and green visible light, and pass through light in a wavelength band corresponding to infrared light, and
wherein the instructions, when executed by the at least one processor individually or collectively, cause the electronic device to:
obtain the infrared image by removing blue and green colors from the image of the projection area received from the image sensor, and
recognize a shape of the subject based on the infrared image.

11. The electronic device of claim 9, wherein the instructions, when executed by the at least one processor individually or collectively, cause the electronic device to:
obtain the visible light image based on the image of the projection area obtained from the image sensor during execution of a first sensing mode, and
obtain the infrared image based on the image of the projection area obtained from the image sensor during execution of a second sensing mode.

12. The electronic device of claim 11, wherein the instructions, when executed by the at least one processor individually or collectively, cause the electronic device to:
adjust an exposure value of the image sensor to a first exposure value and a gain value of the image sensor to a first gain value during the execution of the first sensing mode, and
adjust the exposure value of the image sensor to a second exposure value and the gain value of the image sensor to a second gain value during the execution of the second sensing mode,
wherein the first exposure value is greater than the second exposure value, and
wherein the first gain value is greater than the second gain value.

13. A method of controlling an electronic device, comprising:
projecting, by a projection portion of the electronic device comprising at least one lens, an optical image onto a projection area;
emitting infrared light onto the projection area;
obtaining, by an image sensor of the electronic device, an image of the projection area, wherein the image sensor comprises a dual band pass filter, and the dual band pass filter is configured to block light in a wavelength band corresponding to red visible light, pass through light in wavelength bands corresponding to blue and green visible light, and pass through light in a wavelength band corresponding to infrared light;
obtaining a visible light image and an infrared image based on the image of the projection area;
recognizing position information of a touch point input by a subject within the projection area based on the visible light image and the infrared image; and
controlling an operation of the projection portion based on the recognized position information of the touch point.

14. The method of claim 13, wherein the recognizing the position information of the touch point comprises:
obtaining the infrared image by removing blue and green colors from the image of the projection area,
recognizing a border of the projection area based on the visible light image,
recognizing infrared coordinates and the touch point based on the infrared image, and
recognizing the position information of the touch point based on the recognized border of the projection area, the recognized infrared coordinates, and the recognized touch point.

15. The method of claim 13, wherein the obtaining of the visible light image and the infrared image based on the image of the projection area comprises:
during execution of a first sensing mode, adjusting an exposure value of the image sensor to a first exposure value and adjusting a gain value of the image sensor to a first gain value,
during execution of a second sensing mode, adjusting the exposure value of the image sensor to a second exposure value and adjusting the gain value of the image sensor to a second gain value, the first exposure value being greater than the second exposure value, and the first gain value being greater than the second gain value,
obtaining the visible light image based on the image of the projection area obtained by the image sensor during the execution of the first sensing mode, and
obtaining the infrared image based on the image of the projection area obtained by the image sensor during the execution of the second sensing mode.

16. The electronic device of claim 1, further comprising:
a speaker configured to output audio content,
wherein the instructions, when executed by the at least one processor individually or collectively, cause the electronic device to:
recognize a user input based on the recognized position information of the touch point, and
control an operation of the speaker based on the recognized user input.

17. The electronic device of claim 12, wherein the instructions, when executed by the at least one processor individually or collectively, cause the electronic device to:
adjust the exposure value of the image sensor by controlling a shutter speed of the image sensor or an aperture opening degree of the image sensor.

18. The electronic device of claim 17, wherein the aperture opening degree during execution of the first sensing mode is greater than the aperture opening degree during execution of the second sensing mode.

19. The electronic device of claim 17, wherein the shutter speed during execution of the first sensing mode is faster than the shutter speed during execution of the second sensing mode.

20. The method of claim 13, further comprising:
recognizing a user input based on the recognized position information of the touch point, and
controlling the operation of the projection portion based on the recognized user input.
